(19) United States
(12) Patent Application Publication
(10) Pub. No.: US 2025/0187249 A1
(43) Pub. Date: Jun. 12, 2025

(54) APPARATUS AND METHOD FOR PRODUCING CONTAINERS

(71) Applicant: Krones AG, Neutraubling (DE)

(72) Inventors: Andreas STOPFER, Regensburg (DE); Robert AUST, Illkofen (DE); Peter KUEN, Regensburg (DE); Andreas STEINER, Wenzenbach (DE); Simon FISCHER, Regensburg (DE); Benedikt BOETTCHER, Bruckmühl (DE); Konrad SENN, Alteglofsheim (DE); Markus ZOELFL, Metten (DE)

(21) Appl. No.: 18/970,331

(22) Filed: Dec. 5, 2024

(30) Foreign Application Priority Data
Dec. 11, 2023 (DE) 10 2023 134 557.5

(51) Int. Cl. B29C 49/64; B29C 49/06

(52) U.S. Cl. CPC B29C 49/64; B29C 49/06

(57) ABSTRACT

The present disclosure relates to an apparatus for producing containers which comprises: a control device which is designed to set at least one working parameter for the production of at least one first container, a measuring device that is designed to measure at least one container parameter of the at least one produced first container in order to obtain a measured value of the at least one container parameter, a measurement correction device designed to correct the measured value of the at least one container parameter based on at least one model parameter of a numerical model, and a performance parameter determination device that is designed to determine at least one performance parameter value on the basis of the corrected at least one measured value. The control device is designed to control the production of at least one second container based on the at least one working parameter.

### CROSS REFERENCE TO RELATED APPLICATION

The present application claims priority to German Patent Application No. 10 2023 134 557.5 filed on Dec. 11, 2023. The entire contents of the above-listed application are hereby incorporated by reference for all purposes.

### TECHNICAL FIELD

The present disclosure relates to the field of container production, in particular model-based container production.

### BACKGROUND

Filling plants for beverages or the like comprise a plurality of production units connected in series, such as machines for producing containers, (form) filling machines, labeling machines and packaging machines.

### SUMMARY

For example, in the production of labeled plastic bottles, plastic bottles are first continuously generated from blanks in a rotary blow molding machine. A blow molding machine receives the heated blanks, also called preforms, in appropriately designed blow molds, in which they are then blown into plastic bottles under high pressure and at high temperature during the cycle of the blow molding machine. The plastic bottles generated in this way are then filled and labeled.

In general, the finished containers should meet specified quality requirements, i.e., they should have specified performance parameter values (quality parameter values), such as specified values for top load, burst pressure, stress cracks, material distribution and section weight. The performance parameters are not only used for quality control, but also for optimizing the production process by adjusting working parameters, such as the pressure applied to a plastic preform, the time and duration of the pressure application, and movement parameters of a stretching rod with which the plastic preform is stretched.

The performance parameters cannot be measured inline, but are determined on the basis of measured container parameters such as wall thicknesses, wall thickness profiles, and bottom and side wall inspection measurement data. However, the measured values for the container parameters are typically not sufficiently reliable because they can be influenced by interference parameters such as different surfaces, orientations and geometries of the containers and varying absorption/transmission coefficients of the container material. For example, as illustrated in FIG. 1, the accuracy of optical or ultrasonic measuring methods for measuring wall thicknesses can be impaired by non-uniform container geometries in measuring regions G1 onto which the incidence of the measuring beam M is not perpendicular and in which it therefore passes through more material than in regions G2 onto which the incidence is perpendicular.

It is therefore an object of the present disclosure to provide an apparatus and a method for producing containers, for example plastic or glass bottles, in which the production process is optimized on the basis of precisely determined performance parameter values.

The above-mentioned object is achieved by providing an apparatus for producing containers (for example plastic bottles or glass bottles), which comprises a control device which is designed to set at least one working parameter for producing at least one first container (and therefore to control the production of the at least one first container on the basis of the set at least one working parameter), and a measuring device which is designed to measure at least one container parameter of the at least one produced first container in order to obtain a measured value of the at least one container parameter. Furthermore, the apparatus comprises a measurement correction device which is designed to correct the measured value of the at least one container parameter on the basis of at least one model parameter of a numerical model (which can in particular take into account disturbance parameters of the measurement and environmental data), and a performance parameter determination device which is designed to determine at least one performance parameter value (at least one performance parameter) on the basis of the corrected at least one measured value. Furthermore, the control device is designed to control the production of at least one second container, which is different from the at least one first container, on the basis of the at least one working parameter adapted on the basis of the determined at least one performance parameter value.

The at least one performance parameter can also be determined using a model, which may comprise the above-mentioned numerical model, on the basis of the corrected at least one measured value.

Here and in the following, the term “control device” is used to comprise a control and/or regulating device. Accordingly, the term “control” here comprises controlling (open-loop) and/or regulating (close-loop).

The control device, measurement correction device and performance parameter determination device may be provided at least partially logically and/or physically separate from one another or integrated with one another. In particular, the measurement correction device may be integrated into the performance parameter determination device.

The device may comprise a blow molding machine, for example a rotary blow molding machine.

The at least one working parameter may be selected from the group comprising a pressure applied to a plastic preform, a time and duration of the pressure application and movement parameters of a stretching rod with which the plastic preform is stretched. Furthermore, this group may comprise a control parameter or a manipulated variable of a heating device with which a plastic preform is heated. The heating device may be an infrared oven, microwave oven or laser oven, or a combination thereof. Manipulated variables of the infrared oven comprise, for example, the heating output of the individual heaters or an adjustment of the heaters as a whole, the activation/deactivation of the individual heaters, a cooling output (surface cooling), the individual adjustment of the cooling output along the heating lane in the individual heating boxes, the reflector adjustment in order to be able to make the heating lane smaller/larger, for example by moving the bottom reflector upwards, the immersion depth of the heating mandrel with the plastic preform in the heating lane, and the adjustment of the focus reflector in order to optimize energy input below the support ring. Corresponding manipulated variables can be comprised of the group for a laser furnace. For a microwave oven, the group may comprise the microwave output, the adjustment of elements in the applicator to influence the microwave field, and the adjustment of the functional elements for profiling as manipulated variables.

The at least one container parameter may be selected from the group that comprises a parameter characteristic of a wall thickness of the container (for example, the wall thickness itself or an absorption or transmission capacity—for example: the thicker the wall, the more light of a sensor beam is absorbed), an absorption coefficient of the material of the container, a transmission coefficient of the material of the container, a translucence of the material of the container, a wall thickness profile of the container, a temperature of the container, a height of the container, a diameter of the container and bottom and side wall inspection measurement data of the container, off-center detection data, neck extension measurement data, information data from the production line such as counters of a faulty blowing process, burst bottles at the filler, and lost bottles, and level control data, etc. Measuring the container parameter may comprise direct measurement or determination via a measured value. The at least one performance parameter may be selected from the group that comprises a top load, a ground clearance, a burst pressure, a stress crack, a material distribution and a section weight.

The numerical model may comprise at least one of pieces of information about surfaces (in particular grooves, facets and other surface elements), orientations, geometries of the containers and absorption/transmission coefficients of the container material and parameters of preforms of the containers as the at least one model parameter. Likewise, the model may comprise data from environmental parameters, such as temperature and humidity, as the at least one model parameter. For example, the model may be produced from a plurality of data points and it can allow, for example, to accurately determine material distribution or segment weights based on measured values of one or more container parameters that are characteristic of wall thicknesses. In particular, the model can allow a mathematical calculation of the performance parameter on the basis of the corrected at least one measured value provided by the model. Physical models, an expert system, results from reverse modeling, and look-up tables may be comprised in the model.

The numerical model may generally take into account production parameters and other metadata such as preform inlet temperature, Contiform setting parameters, classification data of bottles and preforms, batch information about the preforms (for example, the production date), object drawings or any product specification data.

The at least one working parameter can be adjusted, for example by the control device, on the basis of the determined at least one performance parameter value. Determining the performance parameter from the corrected measured value can be validated and adjusted by means of a calibration run.

By providing the model-based correction device, more precise values, as compared to the prior art, for performance parameters can be determined based on a model, which can be used to adapt the working parameters of the production process in order to optimize it. The model-based determination of the performance parameters and the working parameters adapted on the basis of these performance parameters determined based on a model allows specified quality criteria to be reliably fulfilled.

According to a further embodiment, the apparatus may comprise an artificial neural network which is designed to create the model (in particular, before the production of the at least one first container). A learning neural network is particularly suitable for creating the model required for correction. Furthermore, it can also be trained on-the-fly during the actual production process. It may therefore be designed to train the model even after the production of the at least one first and/or the at least one second container in order to further optimize the model (for example, through the dynamic adjustment of correction parameters). The control device and/or the measurement correction device and/or the performance parameter determination device may also comprise a neural network. In general, a neural network of the performance parameter determination device can learn and dynamically adapt transformation mappings from the corrected measured values to the performance parameter values.

Furthermore, a filling plant with the apparatus according to one of the above-described examples is provided. The filling plant comprises a series of other machines, such as a filling machine, labeling machine and packaging machine. The control device may be designed to control all machines.

The above-mentioned object is also achieved by providing a method for producing containers, which comprises the steps of: providing a container produced on the basis of at least one working parameter, measuring at least one container parameter (for example, a parameter characteristic of a wall thickness) of the provided container in order to obtain a measured value of the at least one container parameter, correcting the measured value of the at least one container parameter on the basis of at least one model parameter (for example, with information about surfaces, orientations, geometries of the containers and absorption/transmission coefficients of the container material and parameters of preforms of the provided container) of a numerical model, determining at least one performance parameter value on the basis of the corrected at least one measured value, adjusting the at least one working parameter on the basis of the determined at least one performance parameter value, and producing the containers on the basis of the adjusted at least one working parameter. The above description applies to the model and the various parameters. Again, determining the at least one performance parameter value on the basis of the corrected at least one measured value can be carried out using a model which can include said numerical model.

The method may further comprise the creation of the numerical model using a neural network. The neural network can also be (further) trained after producing the containers on the basis of the adjusted at least one working parameter.

In the following, embodiments of an apparatus according to the disclosure and of a method according to the disclosure are described with reference to the drawings. The described embodiments are to be considered in all respects as illustrative and not restrictive, and various combinations of the listed features are included in the disclosure.

### BRIEF DESCRIPTION OF THE FIGURES

FIG. 1 illustrates the effect of a non-uniform container geometry as a disturbance parameter for measuring a container parameter.

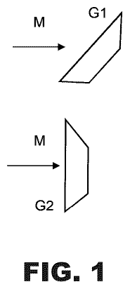

FIG. 2 shows a block diagram that illustrates an apparatus for producing containers according to an embodiment of the present disclosure.

FIG. 3 shows an exemplary filling plant that comprises the apparatus for producing containers according to an embodiment of the present disclosure.

### DETAILED DESCRIPTION

The present disclosure relates to the production of containers. According to the disclosure, working parameters for producing the containers can be adjusted on the basis of performance parameter values that are determined on the basis of measurement data that have been corrected based on a model.

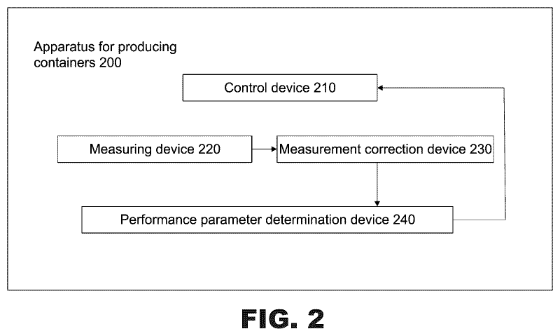

FIG. 2 schematically shows an apparatus 200 for producing containers according to an embodiment. The apparatus 200 may, for example, comprise a blow molding machine for forming containers from preforms. According to the embodiment shown in FIG. 2, the apparatus 200 for producing containers comprises a control device 210 for controlling the production process, which is designed to set working parameters for producing the containers. The working parameters may comprise a pressure that is applied to a plastic preform, the time and duration of pressure application, and movement parameters of a stretching rod with which the plastic preform is stretched. The control device may include a processor and memory holding instructions for carrying out the operations as described herein and operating the model described herein.

The apparatus 200 further comprises a measuring device 220 which is designed to determine at least one container parameter value of the containers (or at least of one of the containers). The container parameters may comprise a parameter characteristic of a wall thickness of the container (for example, the wall thickness itself or an absorption or transmission capacity or an absorption (amount) or transmission (amount)), an absorption coefficient of the material of the container, a transmission coefficient of the material of the container, a wall thickness profile of the container, and bottom inspection measurement data of the bottom of the container.

Furthermore, the apparatus 200 comprises a measurement correction device 230 which is designed to correct measured values of the at least one container parameter provided by the measuring device on the basis of at least one model parameter of a numerical model. The at least one model parameter may comprise at least one piece of information about surfaces, orientations, geometries of the containers and absorption/transmission coefficients of the container material and parameters of preforms of the containers as the at least one model parameter.

The numerical model can be generated by artificial intelligence (AI)/a neural network. The measurement correction device 230 may comprise such an artificial intelligence or such a neural network.

Neural networks can be understood as tools that are suitable for simulating any non-linear functions and therefore also rules of fuzzy logic, for example, if these functions are available with reference to examples that can be used to train the neural network. From a large number of examples, regularities and therefore weightings of the neural networks can be learned/trained, which are then expressed using predefined but also adaptable rules, for example fuzzy sets and rules. The combination of fuzzy controllers with neural networks allows intelligent learning-based setup and parameterization of the fuzzy rules.

The neural network can be a transformer and/or one of a deep (learning) neural network, multilayer perceptron, convolutional neural network and recurrent neural network. The deep (learning) neural network is characterized by a plurality of hidden layers. A machine is enabled by deep learning to improve its capabilities independently and without human involvement and make decisions by extracting and classifying patterns from existing data and information. The insights obtained can in turn be correlated with data and linked in a broader context. Finally, the machine is capable of making decisions based on these links. By continuously questioning the decisions, the information links are given certain weightings. If decisions are confirmed, their weighting increases; if they are revised, the weighting decreases. There are always several hidden intermediate layers and links between the input layer and the output layer. The actual output is decided by the number of intermediate layers and their updated link. The multilayer perceptron represents a relatively simple, robust neural network in which all nodes are fully connected. The convolutional neural network is based on convolutions instead of matrix multiplication. The recursive neural network allows feedback of a neuronal layer to a preceding one. A transformer has neither a convolutional neural network nor a recursive neural network, but is based on the concept of self-attentiveness. However, the transformer can interact with a convolutional neural network or a recursive neural network.

Furthermore, the apparatus 200 comprises a performance parameter determination device 240 which is designed to determine at least one performance parameter value on the basis of the corrected at least one measured value/container parameter value. The at least one performance parameter may comprise a top load, a ground clearance, a burst pressure, a stress crack, a material distribution and a section weight. Determining at least one performance parameter value is also model-based, for example, on the basis of a model that comprises the above-mentioned numerical model.

The control device 210 of the apparatus 200 is furthermore designed to control the production of other containers on the basis of the at least one working parameter adjusted on the basis of the determined at least one performance parameter value. The control of the production of the other containers is therefore based on very precise model-corrected measured values and the performance parameter values obtained therefrom determined on the basis of a model so that the production process can be optimized in a very finely tuned manner.

For example, a measured parameter value characteristic of a wall thickness of a container can be corrected using a model that provides at least information about the geometry of the container and its orientation during the measurement. For example, an infrared beam used for measurement that strikes a side wall of a container perpendicularly passes through less container material than an infrared beam that strikes a conically tapered head region of the same container at an angle not equal to 90°. This situation and the measurement error resulting therefrom can be taken into account and corrected by the model. The corrected parameter value characteristic of the wall thickness of the container (for example, comprising an absorption (amount) of an infrared beam) can then be used to determine the material distribution or segment weights, which is also model-based.

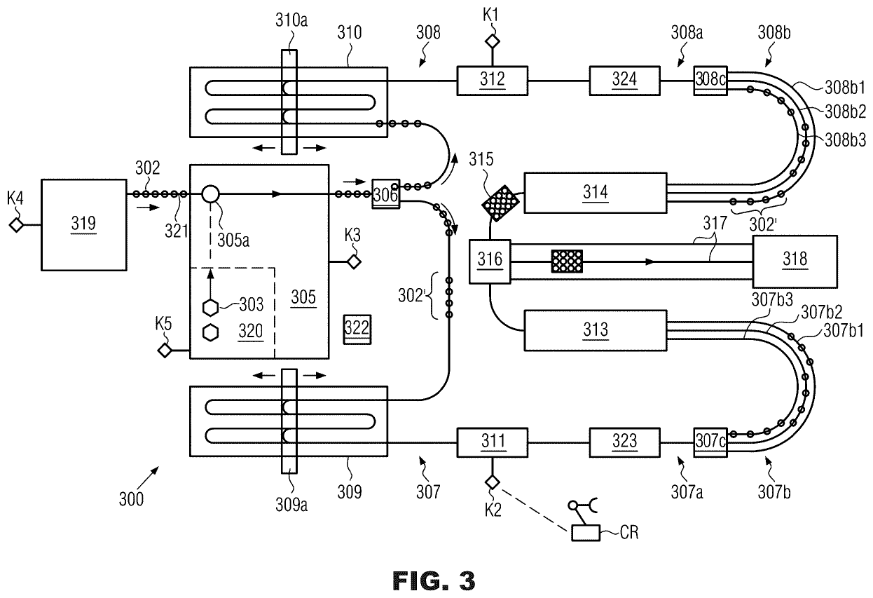

An exemplary filling plant 300, which may contain the apparatus 200 shown in FIG. 2 for producing containers, is shown in FIG. 3. The filling plant 300 for filling containers 302, 303, for example plastic bottles, with a liquid product, such as a beverage or the like, comprises a filling machine 305 for filling and closing the containers 302, 303 and a distribution device 306 provided downstream of the filling machine 305 for distributing the containers 302, 303 to two separately controllable transport paths 307, 308, in each of which at least one container buffer 309, 310 with adjustable container guides 309a, 310a is provided. Downstream of the container buffers 309, 310 are labeling machines 311, 312 and packaging machines 313, 314 for producing container packs 315. These are fed to a collection and distribution device 316 so that the container packs 315 are distributed to sorting tracks 317 provided downstream of the collection and distribution device 316 and can be fed to a picking device 318.

The transport paths 307, 308 each comprise first inlet-side sections 307a, 308a which are single-track and designed for the pressure-free transport of the containers 302, 303. Furthermore, the transport paths 307, 308 comprise second sections 307b, 308b on the output side, which are each designed with multiple lanes for the pressure-free transport of the containers 302, 303. Switches 307c, 308c or corresponding distribution devices are provided for the distribution of the containers 302, 303 from the single-track first section 307a, 308a to the individual tracks of the second section 307b, 308b, which are designed, for example, in the form of separate lanes 307b1 to 307b3, 308b1 to 308b3.

Furthermore, the filling plant 300 comprises two apparatus for producing containers 319, 320 in the form of blow molding machines 319, 320. In the example shown, separate blow molding machines 319, 320 are provided for producing different containers 302, 303, for example, containers of different geometric shapes. At least one of the blow molding machines 319, 320 may be connected to the filling machine 3055 via an input-side transport path 321. Different incoming container streams can be fed for further processing via an input-side switch 305a. Additional production units 323, 324 may be provided in the form of shrink tunnels.

For controlling the filling plant 300 according to the disclosure, a central control/regulation device 322 is provided, which communicates, in particular, with the distribution device 306, the container buffers 309, 310, the labeling machines 311, 312 and production units upstream from the distribution device 306, such as the filling machine 305 and the blow molding machines 319, 320. The central control/regulation device 322 may correspond to the control device 210 of the apparatus 200 shown in FIG. 2 or comprise it.

In the example shown, the labeling machines 311, 312 are connected to their own communication and control devices K1, K2, the filling machine 305 to its own communication and control device K3, and the blow molding machines 319, 320 to their own communication and control devices K4, K5. Each of the communication and control devices K1, K2, K3, K4 allows a user to operate the corresponding machine via a suitable interface. According to one example, the communication and control device K4 or K5 comprises the control device 210 of the apparatus 200 shown in FIG. 2. The communication and control devices K1, K2, K3, K4, K5 are logically assigned to the respective machines of the filling plant 300. Of course, all machines of the filling plant 300 can be equipped with their own communication and control devices, and the communication and control devices can be networked with each other so that they can exchange information about the operating states of the machines and the requirements of the operators. In general, for security reasons, the networking of the communication and control device with the other machines, mobile collaborative robots (CR), but also smartphones of the operators, etc. can be limited to a defined internal region (for example, in the form of a company's network), and at the same time an exchange on the Internet for independent learning by the communication and control device can be made possible, for example with regard to speech recognition or speaker identification.

The central control/regulation device 322 is connected to the communication and control devices K1, K2, K3, K4, K5 and can at least partially take over the coordination of the machines and transport technology, for example, for organizing the plant production and the changeover of the types of products. Logically and/or physically, each machine can be assigned a communication and control device K1, K2, K3, K4, K5. An operator can operate the respective machines via the communication and control devices K1, K2, K3, K4, K5, for example, by means of voice entries and voice dialogs. The communication and control devices K1, K2, K3, K4, K5 can use display devices that are positioned near the machines to display information. Implementations with central and distributed data processing and databases that the central control/regulation device 322 and the communication and control devices K1, K2, K3, K4, K5 can access are possible.

1. An apparatus for producing containers, comprising:
a control device which is designed to set at least one working parameter for producing at least one first container;
a measuring device which is designed to measure at least one container parameter of the at least one produced first container in order to obtain a measured value of the at least one container parameter;
a measurement correction device which is designed to correct the measured value of the at least one container parameter on the basis of at least one model parameter of a numerical model;
a performance parameter determination device which is designed to determine at least one performance parameter value on the basis of the corrected at least one measured value;
and wherein
the control device is designed to control the production of at least one second container, which is different from the at least one first container, on the basis of the at least one working parameter adapted on the basis of the determined at least one performance parameter value.

2. The apparatus according to claim 1, which further comprises a neural network that is configured to create the model.

3. The apparatus according to claim 2, in which the neural network is designed to train the model after the production of the at least one first and/or the at least one second container.

4. The apparatus according to claim 1, in which the measuring device is designed to measure a parameter characteristic of light transmission.

5. The apparatus according to claim 1, in which the model comprises at least one piece of information about surfaces, orientations, geometries of the containers and absorption/transmission coefficients of the container material, and parameters of preforms of the containers as the at least one model parameter.

6. A method for producing containers, having the steps of:
providing a container produced on the basis of at least one working parameter;
measuring at least one container parameter of the provided container in order to obtain a measured value of the at least one container parameter;
correcting the measured value of the at least one container parameter on the basis of at least one model parameter of a numerical model;
determining at least one performance parameter value on the basis of the corrected at least one measured value;
adjusting the at least one working parameter on the basis of the determined at least one performance parameter value; and
producing the containers on the basis of the adjusted at least one working parameter.

7. The method according to claim 6, further including creating the numerical model using a neural network.

8. The method according to claim 7, further including training the neural network after producing the containers on the basis of the adjusted at least one working parameter.

9. The method according to claim 6, in which the container parameter is a parameter characteristic of light transmission.

10. The method according to claim 6, in which the model comprises at least one piece of information about surfaces, orientations, geometries of the containers and absorption/transmission coefficients of the container material, and parameters of preforms of the containers as the at least one model parameter.

11. The apparatus according to claim 4, wherein the parameter characteristic of light transmission is a wall thickness of the first container.

12. The method according to claim 9, wherein the parameter characteristic of light transmission is a wall thickness of the first container.
